(19) United States
(12) Patent Application Publication
(10) Pub. No.: US 2024/0217389 A1
(43) Pub. Date: Jul. 4, 2024

(54) MODELLING OF ELECTRIC VEHICLE CHARGING AND DRIVING USAGE BEHAVIOR WITH VEHICLE-BASED CLUSTERING

(71) Applicant: Volkswagen Aktiengesellschaft, Wolfsburg (DE)

(72) Inventors: Gianina Alina Negoita, San Leandro, CA (US); William Paxton, Redwood City, CA (US); Matthew Yen, Bellaire, TX (US)

(21) Appl. No.: 18/091,294

(22) Filed: Dec. 29, 2022

(51) Int. Cl. B60L 58/16; B60L 58/12; G06F 16/906

(52) U.S. Cl. CPC B60L 58/16; B60L 58/12; G06F 16/906

(57) ABSTRACT

Technologies and techniques for processing a state of health for a battery in a battery management system. A plurality of time series windows are extracted from a multivariate time series battery-related data associated with a plurality of vehicles. One or more data features are extracted from the plurality of time series windows and clustered to group the data features into a plurality of first groups, based on a similarity metric. Each of the clustered plurality of first groups are labeled with correlated values indicating a state, and a plurality of label compositions are generated, each label composition comprising an aggregation of vehicles associated with each label. The plurality of label compositions are clustered to determine vehicle clusters sharing the most similar usage patterns. A state of health indication may then be for the battery information based on the vehicle clusters sharing the most similar usage patterns.

### TECHNICAL FIELD

The present disclosure relates to methods, apparatuses, and systems for a battery management system (BMS) and, more particularly, to a BMS that uses hierarchical clustering approaches for battery usage behavior generation.

### BACKGROUND

Electric vehicles (EV) and electric cars are becoming a more viable option for many drivers. During use, EV batteries will slowly lose capacity over time, with current EVs averaging around 2% of range loss per year. Over many years, the driving range may be noticeably reduced. EV batteries can be serviced and individual cells inside the battery can be replaced if they go bad. However, there's the risk after many years of service and several hundred thousand miles that the entire battery pack may need to be replaced if it has degraded too much. Often times, charging and driving usage behavior by drivers will affect how quickly or slowly an EV battery may degrade.

Many advanced battery operations require assumptions about how a battery will be used. For EVs, battery usage is determined by the behavioral characteristics of the driver(s) and the availability of charging facilities. However, understanding patterns in human behavior, particularly for EV usage is very difficult, especially as it is represented in multivariate time series signals. Determining similarities between multivariate time series is a challenging task.

Clustering from time series data involves a pipeline of data manipulation steps. When features for clustering are not chosen properly, the data will produce poor quality results. Similarly, when a clustering algorithm is poorly formulated (e.g., bad parameter threshold), undesired cluster borders are obtained with mix of overlapping features in one cluster, which also results in inferior-quality data. There is a need to improve cluster identification, compared to purely data-based feature extraction.

### SUMMARY

Various apparatus, systems and methods are disclosed herein relating to controlling operation of a vehicle. In some illustrative embodiments, a battery management system for processing a state of health for a battery is disclosed, comprising: at least one data storage configured to store computer program instructions; and at least one processor, operatively coupled to the at least one data storage, wherein the at least one processor is configured to: extract a plurality of time series windows from a multivariate time series data associated with a plurality of vehicles, the multivariate time series data comprising battery information data for the vehicles; extract one or more data features from the plurality of time series windows; cluster the processed extracted data features to group the data features into a plurality of first groups, based on a similarity metric; label each of the clustered plurality of first groups with correlated values indicating a state; generate a plurality of label compositions, each label composition comprising an aggregation of vehicles associated with each label; cluster the plurality of label compositions to determine vehicle clusters sharing the most similar usage patterns; and determine a state of health indication for the battery information based on the vehicle clusters sharing the most similar usage patterns.

In some examples, a computer-implemented method of processing a state of health for a battery in a battery management system is disclosed, comprising: extracting a plurality of time series windows from a multivariate time series data associated with a plurality of vehicles, the multivariate time series data comprising battery information data for the vehicles; extracting one or more data features from the plurality of time series windows; clustering the processed extracted data features to group the data features into a plurality of first groups, based on a similarity metric; labeling each of the clustered plurality of first groups with correlated values indicating a state; generating a plurality of label compositions, each label composition comprising an aggregation of vehicles associated with each label; clustering the plurality of label compositions to determine vehicle clusters sharing the most similar usage patterns; and determining a state of health indication for the battery information based on the vehicle clusters sharing the most similar usage patterns.

In some examples, a non-transitory computer-readable medium is disclosed, storing executable instructions for processing a state of health for a battery for a battery management system, when executed by one or more processors, causes one or more processors to: extract a plurality of time series windows from a multivariate time series data associated with a plurality of vehicles, the multivariate time series data comprising battery information data for the vehicles; extract one or more data features from the plurality of time series windows; cluster the processed extracted data features to group the data features into a plurality of first groups, based on a similarity metric; label each of the clustered plurality of first groups with correlated values indicating a state; generate a plurality of label compositions, each label composition comprising an aggregation of vehicles associated with each label; cluster the plurality of label compositions to determine vehicle clusters sharing the most similar usage patterns; and determine a state of health indication for the battery information based on the vehicle clusters sharing the most similar usage patterns.

### BRIEF DESCRIPTION OF THE FIGURES

The present invention is illustrated by way of example and not limitation in the figures of the accompanying drawings, in which like references indicate similar elements and in which:

FIG. 1 shows an exemplary vehicle system block diagram showing multiple components and modules according to some aspects of the present disclosure;

FIG. 2 shows an exemplary network environment illustrating communications between a vehicle and a server/cloud network according to some aspects of the present disclosure;

FIG. 3 shows an exemplary block diagram of utilizing machine learning and clustering with desired cluster borders according to some aspects of the present disclosure;

FIG. 4 shows an exemplary high-level block diagram flowchart for an artificial intelligence pipeline according to some aspects of the present disclosure;

FIG. 5A shows an illustrative machine learning AI pipeline comprising preprocessing multivariate time series data, optional dimensionality reduction step, initial load type clustering, and final VIN clustering according to some aspects of the present disclosure;

FIG. 5B shows a continuation of the machine learning AI pipeline of FIG. 5A according to some aspects of the present disclosure;

FIG. 6 illustrates a simulated chart showing different processes for processing missing values in time series data according to some aspects of the present disclosure;

FIG. 7A shows a simulated chart showing vehicle and battery data according to some aspects of the present disclosure;

FIG. 7B shows a simulated chart showing engineered features extracted from the vehicle and battery data of FIG. 5A according to some aspects of the present disclosure;

FIG. 8 shows an illustrative process for segmenting multivariate time series data, followed by dimensionality reduction of each time series sub-sequence according to some aspects of the present disclosure;

FIG. 9 shows an illustration of a process for clustering multivariate time series data according to some aspects of the present disclosure;

FIG. 10 shows an illustrative two-step clustering process in which different load types are determined, followed by a probability for a given vehicle exhibiting each load type according to some aspects of the present disclosure;

FIG. 11 illustrates a simulated chart demonstrating a process for determining the optimal number of clusters through Silhouette score, inertia, and Davies-Bouldin index according to some aspects of the present disclosure; and

FIG. 12 shows a flowchart illustrating a process for processing a state of health for a battery under some aspects of the present disclosure.

### DETAILED DESCRIPTION

The figures and descriptions provided herein may have been simplified to illustrate aspects that are relevant for a clear understanding of the herein described devices, structures, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Exemplary embodiments are provided throughout so that this disclosure is sufficiently thorough and fully conveys the scope of the disclosed embodiments to those who are skilled in the art. Numerous specific details are set forth, such as examples of specific components, devices, and methods, to provide this thorough understanding of embodiments of the present disclosure. Nevertheless, it will be apparent to those skilled in the art that specific disclosed details need not be employed, and that exemplary embodiments may be embodied in different forms. As such, the exemplary embodiments should not be construed to limit the scope of the disclosure. In some exemplary embodiments, well-known processes, well-known device structures, and well-known technologies may not be described in detail.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises.” “comprising.” “including,” and “having.” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on.” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent.” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

The disclosed embodiments may be implemented, in some cases, in hardware, firmware, software, or any tangibly-embodied combination thereof. The disclosed embodiments may also be implemented as instructions carried by or stored on one or more non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

It will be understood that the term “module” as used herein does not limit the functionality to particular physical modules, but may include any number of tangibly-embodied software and/or hardware components. In general, a computer program product in accordance with one embodiment comprises a tangible computer usable medium (e.g., standard RAM, an optical disc, a USB drive, or the like) having computer-readable program code embodied therein, wherein the computer-readable program code is adapted to be executed by a processor (working in connection with an operating system) to implement one or more functions and methods as described below. In this regard, the program code may be implemented in any desired language, and may be implemented as machine code, assembly code, byte code, interpretable source code or the like (e.g., via Scalable Language (“Scala”), C, C++, C#, Java, Actionscript, Objective-C, Javascript, CSS, XML, etc.).

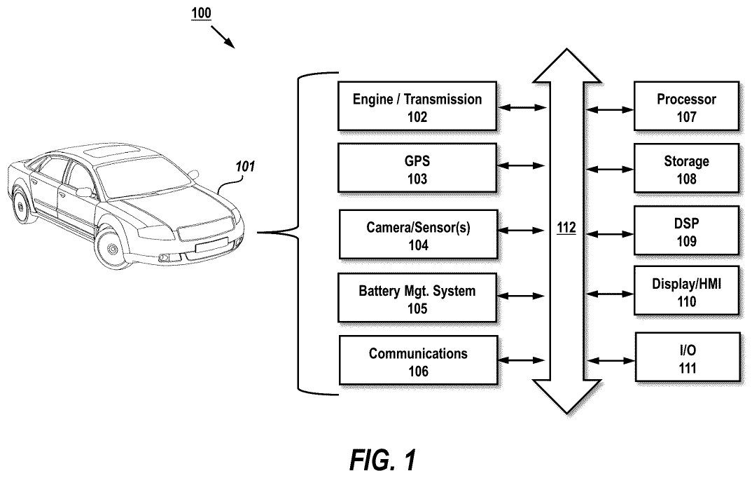

Turning to FIG. 1, the drawing illustrates an exemplary system 100 for a vehicle 101 comprising various vehicle electronics circuitries, subsystems and/or components. Engine/transmission circuitry 102 is configured to process and provide vehicle engine and transmission characteristic or parameter data, and may comprise an engine control unit (ECU), and a transmission control. For electric vehicles, the ECU may be configured as an electric drive controller (EDC) that works in conjunction with battery management system (BMS) 105. In some examples, the BMS monitors the various characteristics of vehicle power, including battery temperature, battery voltage, battery current, and battery charging and discharging data. This information can be stored locally by the BMS 105 and/or the processor 107. The BMS 105 can also transmit such monitored information via the vehicle communications circuitry 106 to an external storage device (e.g., in the cloud). The BMS 105 may regulate the operating conditions of the vehicle power/battery, and perform functions such as regulating the battery temperature to within a predefined threshold temperature.

For a diesel engine, circuitry 102 may provide data relating to fuel injection rate, emission control, NOx control, regeneration of oxidation catalytic converter, turbocharger control, cooling system control, and throttle control, among others. For a gasoline and/or hybrid engine, circuitry 102 may provide data relating to lambda control, on-board diagnostics, cooling system control, ignition system control, lubrication system control, fuel injection rate control, throttle control, and others. Transmission characteristic data may comprise information relating to the transmission system and the shifting of the gears, torque, and use of the clutch. Under one embodiment, an engine control unit and transmission control may exchange messages, sensor signals and control signals for any of gasoline, hybrid and/or electrical engines.

Global positioning system (GPS) circuitry 103 provides navigation processing and location data for the vehicle 101. The camera/sensors 104 provide image or video data (with or without sound), and sensor data which may comprise data relating to vehicle characteristic and/or parameter data (e.g., from 102), and may also provide environmental data pertaining to the vehicle, its interior and/or surroundings, such as temperature, humidity and the like, and may further include LiDAR, radar, image processing, computer vision and other data relating to manual, semi-autonomous and/or autonomous (or “automated”) driving and/or assisted driving.

Communications circuitry 106 allows any of the circuitries of system 100 to communicate with each other and/or external devices (e.g., devices 202-203) via a wired connection (e.g., Controller Area Network (CAN bus), local interconnect network, etc.) or wireless protocol, such as 3G, 4G, 5G, Wi-Fi, Bluetooth, Dedicated Short Range Communications (DSRC), cellular vehicle-to-everything (C-V2X) PC5 or NR, and/or any other suitable wireless protocol. While communications circuitry 106 is shown as a single circuit, it should be understood by a person of ordinary skill in the art that communications circuitry 106 may be configured as a plurality of circuits. In one embodiment, circuitries 102-106 may be communicatively coupled to bus 112 for certain communication and data exchange purposes.

Vehicle 101 may further comprise a main processor 107 (also referred to herein as a “processing apparatus”) that centrally processes and controls data communication throughout the system 100. The processor 107 may be configured as a single processor, multiple processors, or part of a processor system. In some illustrative embodiments, the processor 107 is equipped with autonomous driving and/or advanced driver assistance circuitries and infotainment circuitries that allow for communication with and control of any of the circuitries in vehicle 100. Storage 108 may be configured to store data, software, media, files and the like, and may include sensor data, machine-learning data, fusion data and other associated data, discussed in greater detail below. Digital signal processor (DSP) 109 may comprise a processor separate from main processor 107, or may be integrated within processor 107. Generally speaking, DSP 109 may be configured to take signals, such as voice, audio, video, temperature, pressure, sensor, position, etc. that have been digitized and then process them as needed. Display 110 may consist of multiple physical displays (e.g., virtual cluster instruments, infotainment or climate control displays). Display 110 may be configured to provide visual (as well as audio) indicial from any circuitry in FIG. 1, and may be a configured as a human-machine interface (HMI), LCD, LED, OLED, or any other suitable display. The display 110 may also be configured with audio speakers for providing audio output. Input/output circuitry 111 is configured to provide data input and outputs to/from other peripheral devices, such as cell phones, key fobs, device controllers and the like. As discussed above, circuitries 102-111 may be communicatively coupled to data bus 112 for transmitting/receiving data and information from other circuitries.

In some examples, when vehicle 101 is configured as an autonomous vehicle, the vehicle may be navigated utilizing any level of autonomy (e.g., Level 0-Level 5). The vehicle may then rely on sensors (e.g., 104), actuators, algorithms, machine learning systems, and processors to execute software for vehicle navigation. The vehicle 101 may create and maintain a map of their surroundings based on a variety of sensors situated in different parts of the vehicle. Radar sensors may monitor the position of nearby vehicles, while video cameras may detect traffic lights, read road signs, track other vehicles, and look for pedestrians. LiDAR sensors may be configured bounce pulses of light off the car's surroundings to measure distances, detect road edges, and identify lane markings. Ultrasonic sensors in the wheels may be configured to detect curbs and other vehicles when parking. The software (e.g., stored in storage 108) may processes all the sensory input, plot a path, and send instructions to the car's actuators, which control acceleration, braking, and steering. Hard-coded rules, obstacle avoidance algorithms, predictive modeling, and object recognition may be configured to help the software follow traffic rules and navigate obstacles.

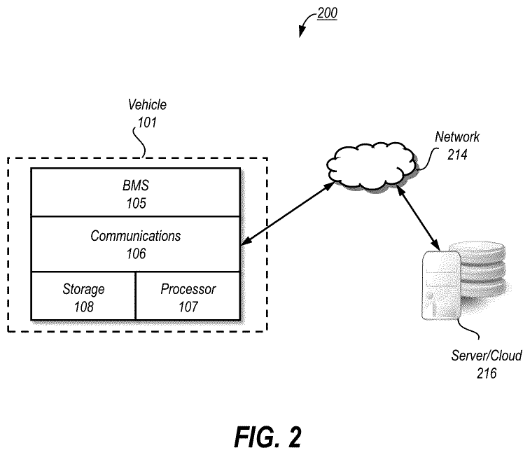

Turning to FIG. 2, the figure shows an exemplary network environment 200 illustrating communications between a vehicle 101 and a server/cloud network 214 according to some aspects of the present disclosure. In this example, the vehicle 101 of FIG. 1 is shown with storage 108, processing apparatus 107 and communications circuitry 106 that is configured to communicate via a network 214 to a server or cloud system 214. It should be understood by those skilled in the art that the server/could network 214 may be configured as a single server, multiple servers, and/or a computer network that exists within or is part of a cloud computing infrastructure that provides network interconnectivity between cloud based or cloud enabled application, services and solutions. A cloud network can be cloud based network or cloud enabled network. Other networking hardware configurations and/or applications known in the art may be used and are contemplated in the present disclosure.

In some examples, the battery management system (BMS) 105 of vehicle is configured to manage the electronics of a rechargeable battery, whether a cell or a battery pack, to ensure that the cell operates within its safe operating parameters. The BMS 105 monitors the State Of Health (SOH) of the battery, collects data, controls environmental factors that affect the cell, and balances them to ensure the same voltage across cells. The BMS 105 is communicatively coupled to communications 106 for transmitting and receiving data, including fuel gauge integration, smart bus communication protocols, General Purpose Input Output (GPIO) options, cell balancing, wireless charging, embedded battery chargers, and protection circuitry, and other data associated with the battery's power status. The BMS 105 may also be configured to manage its own charging, generate error reports, detect and notify the device of any low-charge condition, and predict how long the battery will last or its remaining run-time. The BMS 105 also provides information about the current, voltage, and temperature of the cell and continuously self-corrects any errors to maintain its prediction accuracy.

Generally, the BMS 105 is configured to perform numerous functions including monitoring battery parameters to determine the state of a cell. The cell state may be represented by such parameters as voltage, indicating a cell's total voltage, the battery's combined voltage, maximum and minimum cell voltages, and so on. Other parameters include temperature, to determine an average cell temperature, coolant intake and output temperatures, and the overall battery temperature, the state of charge of the cell to show the battery's charge level, and the cell's state of health (SOH), indicating the remaining battery capacity as a percentage of the original capacity. Further parameters may include the cell's state of power, showing the amount of power available for a certain duration given the current usage, temperature, and other factors, the cell's state of safety, determined by monitoring all the parameters and determining if using the cell poses any danger, the flow of coolant and its speed, and the flow of current into and out of the cell.

Another function of the BMS 105 includes managing thermal temperatures. A battery's thermal management system monitors and controls the temperature of the battery. These systems can either be passive or active, and the cooling medium can either be a non-corrosive liquid, air, or some form of phase change. The BMS 105 may further calculate various battery values, based on parameters such as maximum charge and discharge current to determine the cell's charge and the discharge current limits. These parameters include the energy in kilowatt-hour(s) (kWh) delivered since the last charge cycle, the internal impedance of a battery to measure the cell's open-circuit voltage, charge in Ampere per hour (Ah) delivered or contained in a cell (also known as the Coulomb counter) to determine the cell's efficiency, total energy delivered and operating time since the battery started being used, and total number of charging-discharging cycles the battery has gone through.

The BMS 105 may also include controllers that communicate internally with the hardware at a cellular level and externally with connected devices, including network 214 and server/cloud 216. The external communications may be configured through a centralized controller, and it can be communicated using several methods, including different types of serial communications, CAN bus communicators, DC-BUS communications, and/or various types of wireless communication including radio, pagers, cellphones, etc.

In some examples, the BMS 105 operates independently and/or in conjunction with other vehicle 101 components (e.g., 102, 106, 107, 108, 109) to make determinations on how a battery will be used. The battery usage may be determined by the behavioral characteristics of the driver(s) and the availability of charging facilities. In some examples, patterns in driver behavior may be analyzed as a representation of multivariate time series signals. Using cluster identification, objects may be partitioned into homogenous clusters, where objects within a cluster are classified as similar and objects in different clusters are classified as dissimilar. Once the underlying patterns are determined, usage behavior is classified and can be made predictable.

As will be explained in greater detail below, clustering from time series data may include a pipeline of data manipulation steps, including, but not limited to, interpolation, sampling adjustments, feature engineering, and a mathematical representation of the data to determine quantitative similarity. If adequate features are extracted from input data, desired cluster borders may be determined to separable clusters. The extracted features should be selected and configured to avoid undesired cluster borders and mixing of overlapping features in one cluster. The present disclosure improves cluster identification for battery usage data by detecting underlying patterns.

As such, technologies and techniques of the present disclosure can be implemented for identifying clusters of similar EV charging and driving behaviors. Clustering can be particularly useful for a targeted time series data preprocessing pipeline. Once the preprocessing is complete, a user can train multiple forecast models for different clusters of the time series data, or can include the clustering configuration as metadata for the overall time series analysis. This can be done to improve state of health (SOH) prediction models for EVs using easily accessible and simple pack level data.

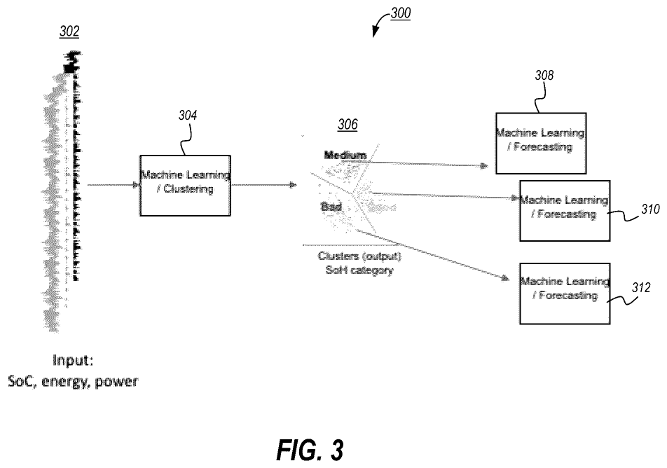

FIG. 3 shows an exemplary block diagram 300 of utilizing machine learning and clustering with desired cluster borders according to some aspects of the present disclosure. In this example, battery data 302 is input into a machine learning and clustering system 304 to produce an output of clusters 306. Clustering from time series data involves a pipeline of data manipulation steps that may include interpolation, sampling adjustments, feature engineering, and a mathematical representation of the data to determine quantitative similarity. If adequate features are extracted from input data, desired cluster borders may be obtained (marked with lines in 306), showing distinctly separable clusters. The identified clusters may then be relabeled with respect to correlated values indicating a state (e.g., “good”, “medium”, “bad”) and subjected to further machine learning/forecasting 808, 310, 312 for each respective value. One example of such processing is provided in U.S. Pat. No. 11,360,155, titled “Battery state of health estimator”, issued on Jun. 14, 2022, and is incorporated by reference in its entirety herein.

However, as mentioned above, when features are not chosen properly, the data will produce poor quality results. Similarly, when a clustering algorithm is poorly formulated (e.g., bad parameter threshold), undesired cluster borders are obtained with mix of overlapping features in one cluster, which also results in inferior-quality data. Aspects of the present disclosure are directed to improving the cluster identification by extracting adequate features based on induced domain knowledge in contrary to purely data-based feature extraction, such as Principal Component Analysis (PCA). Moreover, clustering should first be applied to segmented data to extract load types and subsequently aggregate these load types together for each vehicle. Initially, each vehicle may be characterized by the probability of exhibiting each load type, and then a second round of clustering is performed in order to group the entire VINs.

Generally, clustering may be performed to draw insights, where the data may be grouped, based on a similarity measure. Next, other algorithms may be used on each cluster separately. In some examples, the present disclosure illustrates a two-level approach for hierarchical clustering while also including domain-knowledge feature engineering and time series segmentation and representation. Combining domain knowledge induced features with two cluster methods to learn the data representation together yields better clustering performance. These technologies and techniques may be applied to give data insights into battery usage by detecting patterns with specific characteristics during the lifetime of the battery using the two-level clustering. Further, using clustering as a preprocessing step for another AI algorithm enables faster training times and better accuracy than when not using clustering as a preprocessing step. Clustering can be a valuable addition to the target time series data preprocessing pipeline. Once the preprocessing is complete, one skilled in the art can train multiple forecast models for different clusters of the time series data, or can include the clustering configuration as metadata for the overall time series analysis. This can be done to improve state of health prediction models for electric vehicles using easily accessible and simple pack level data.

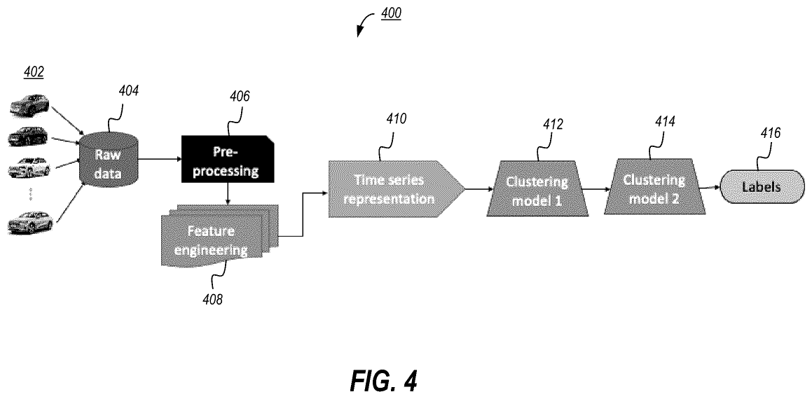

FIG. 4 shows an exemplary high-level block diagram flowchart 400 for an artificial intelligence pipeline according to some aspects of the present disclosure. Generally, each of a plurality of vehicles 402 communicate raw data 404 which may be stored in a storage, such as one associated with a sever/cloud (216). The raw data 404 is then subjected to pre-processing 406 before feature engineering is performed in block 408. Each of the extracted features from 408 may then undergo time series representation processing in 410 before being subjected to a first clustering model 412 using time window segments and UMAP embeddings to determine different load types present in the data. The cluster model 412 is processed and characterized by the probability of exhibiting each load type, which is then used as features for input to a second clustering model 414 to determine quantitative similarity and label 416 the dataset.

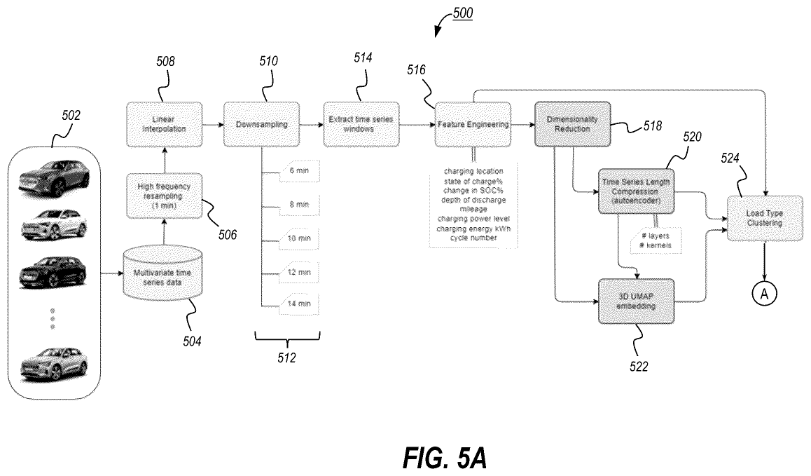

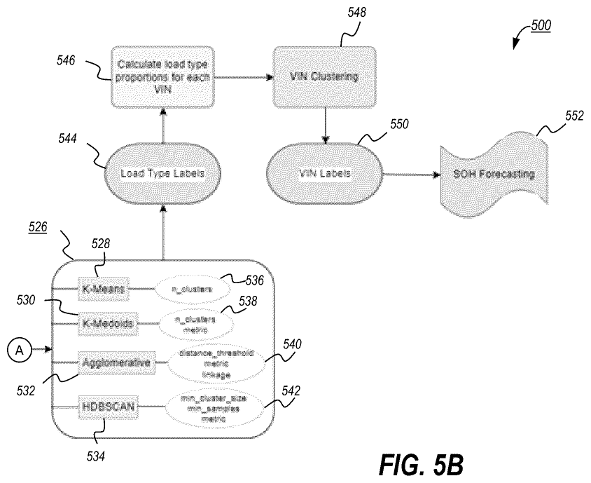

FIG. 5A shows an illustrative machine learning AI pipeline 500 comprising preprocessing multivariate time series data, optional dimensionality reduction step, initial load type clustering, and final VIN clustering according to some aspects of the present disclosure. The illustration of pipeline 500 may be considered a more detailed representation of the high-level block diagram flowchart 400 of FIG. 4. In the example of FIG. 5A, vehicle data from vehicles 502, each of which may be configured similarly to vehicle 101, are collected and stored as multivariate time series data in storage 504. Each vehicle can be referred to by a unique vehicle identification number (VIN). The multivariate time series data for each VIN 502 may include a plurality of time-dependent variables, and each variable depends not only on its past values but also has some dependency on other variables. In a simplified example, for n time series variables {y₁ₜ}, {y₂ₜ} . . . , {yₙₜ} for a vehicle (502), a multivariate time series may be the (n×1) vector time series {Yₜ} where the i^{th} row of {Yₜ} is {yᵢₜ}. That is, for any time t, Yₜ=(y₁ₜ, y₂ₜ . . . , yₙₜ). The multivariate time series data is then resampled (e.g., upsampled) in block 506 to modify the frequency of the time series observations. In some examples, the fine grain resampling interval of the multivariate time series data in block 506 may be selected to be short enough to reflect a robust data set for processing (e.g., 1 minute), without over-sampling or under-sampling. In time series, resampling ensures that the data is distributed with a consistent frequency. Resampling can also provide a different perception of looking at the data, in other words, it can add additional insights about the data based on the resampling frequency or interval.

The amount of time between measurements matter, in that the time periods will translate to rates of change in a state of charge (SOC) and time spent at any SOC value, in which both may be highly influential on battery degradation. Imposing sampling regularity to the time series will ensure that data misinterpretation of the driving and charging profiles is minimized. In block 508, interpolation is performed on the resampled data to fill in any missing values as a result of the resampling in block 506. In some examples, linear interpolation is used in block 508 by applying a process of curve fitting using linear polynomials to construct new data points within the range of a discrete set of known data points. In some examples, forward fill and/or backward fill may be used to interpolate missing values, where forward fill may use the value directly prior to fill the missing value and backward fill may use the value after to fill missing data points.

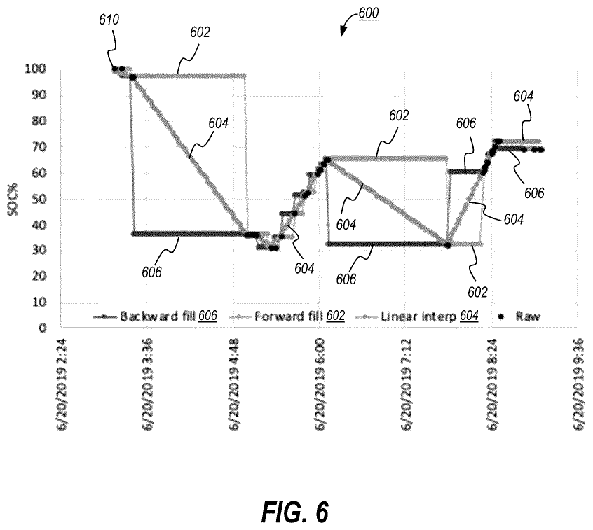

FIG. 6 illustrates a simulated chart 600 showing different processes for processing missing values in time series data according to some aspects of the present disclosure. In some examples, forward/backward fill may assume that the missing values are replaced by repeating the current/next value. In this example, resampling through backward fill is designated as 606, forward fill is designated as 602 and linear interpolation is designated as 604, where the black data points 610 designate original values. As can be seen in the figure, the fill methods may lead to bias towards lower/higher values during charging/discharging, and result in very sudden changes of SOC when available data points are further apart in time. On the other hand, linear interpolation assumes only linear changes in values, which may be a desirable assumption for modeling.

Generally, linear interpolation provides a good approximation that matches up well with the changes in SOC that may appear in more densely recorded areas. During linear interpolation, the individual time series data points may be subjected to linear interpolation, wherein the process searches for lines that passes through end points of each of the time series data points. The linear interpolation imposes regularity to the time series data for further processing in the AI pipeline, and processing missing values assists in the interpretation of time series profiles and model learning. The amount of time (time scale) between measurements may be adjusted to affect the interpretation of rates of change and time spent at a value, both of which are important for accurately modeling driving and charging behavior.

Turning back to the example of FIG. 5A, the multivariate time series data is resampled (506) to a higher frequency to capture as much information from the available data points as possible, which is subjected to linear interpolation 508 at a configured (e.g., 1-minute) sampling frequency. Once linear interpolation is performed in block 508, the interpolated time series data may then be down sampled in block 510 to compress the data to one or more configured time periods 510. In this example, the down sampling may be performed on any of the shown 6-, 8-, 10-, 12- and 14-minute time scales. The interpolated data is down sampled in 510 to minimize excess memory usage for analyzing the time series, and to limit the complexity of the clustering models, especially if the preprocessing is transferred over to larger datasets and longer time series. Since degradation of battery health occurs over a long period of time, it should be sufficient to use lower sampling frequencies 512 (e.g., 6-, 8-, 10-, 12- and 14-minute time scales). Of course, other time periods may be used, depending on the application.

After down sampling 510, the process 500 moves to block 514, where the (down sampled) multivariate time series data may be divided into segments/windows. If adjacent windows overlap, they may be considered “overlapping” sliding windows. If adjacent windows do not overlap, they may be considered “non-overlapping” windows. The window size should be selected such that each window includes enough data points to be differentiable from similar movements. Consider a time series data xᵢ∈ [symbol] at times tᵢ ∈ [symbol] . Generally speaking, assuming a constant sampling rate ΔT=tᵢ₊₁−tᵢ=const. ∀i∈ [symbol] . Each window may comprise of n (n∈ [symbol] , n>1) data points, so the window size may be configured as w=n ΔT. For overlapping windows, a fraction of the data may be shared between consecutive windows, denoted by L∈{1, 2, 3, . . . , n−1} as the number of data points within the overlapping range, where L=Ø signifying the non-overlapping case. In some examples, non-overlapping sliding windows are extracted from the entire time series dataset to obtain time series segments.

After down sampling (510) and time series window extraction (514), the data is subjected to feature engineering in block 516. Generally, feature engineering refers to the process of using domain knowledge to select and transform the most relevant variables from raw data when creating a predictive model using machine learning or statistical modeling. The feature engineering of block 516 performs preprocessing steps that transform the raw data into features that can be used in machine learning algorithms, such as predictive models (524, 526, 548). The feature engineering of block 516 may be configured to perform creation, transformation, extraction, and selection of features (also known as variables), that are most conducive to creating accurate algorithms. Feature creation may involve identifying the variables that will be most useful in the predictive model. In some examples, existing features may be mixed via addition, subtraction, multiplication, and ratio to create new derived features that have additional predictive power. In the example of FIG. 5A, some features of interest may include, but are not limited to, charging location for a vehicle, state of charge %, change in SOC %, depth of discharge, charging power level, charging energy (kWh), and/or cycle number (cycle count). Transformation may be performed in block 516 to manipulate predictor variables to improve model performance (e.g., ensuring the model is flexible in the variety of data it can ingest), ensure variables are on the same scale, make the model easier to understand, improve accuracy, and avoid computational errors by ensuring all features are within an acceptable range for the model.

Feature engineering of block 516 may also be configured to preprocess the data for feature extraction which creates variables by extracting them from raw data. The purpose of feature extraction is to automatically reduce the volume of data into a more manageable set for modeling (e.g., cluster analysis, principal components analysis, etc.). Other pre-processing steps may include data augmentation, cleaning, delivery, fusion, ingestion, and/or loading. Feature selection may also be configured to analyze, judge, and rank various features to determine which features are irrelevant and should be removed, which features are redundant and should be removed, and which features are most useful for the model and should be prioritized.

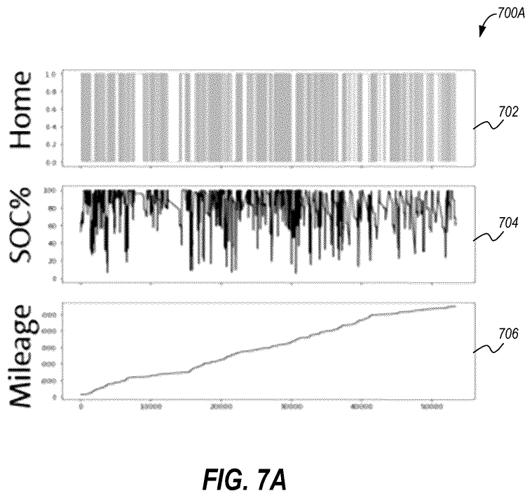

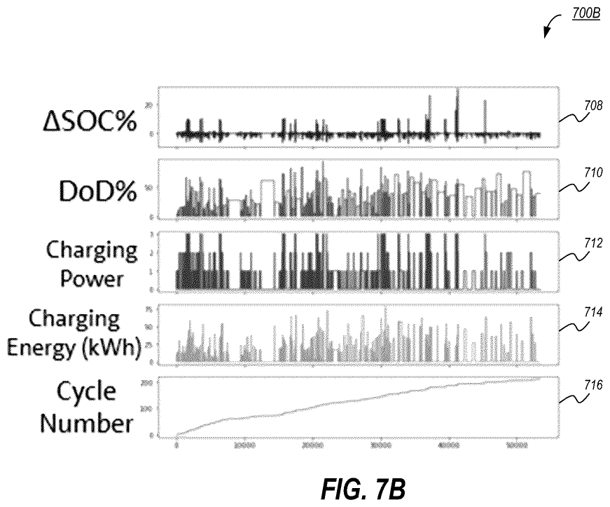

FIGS. 7A and 7B illustrate an example of feature extractions. FIG. 7A shows a simulated chart 700A showing vehicle and battery data, and FIG. 7B shows a simulated chart 700B showing engineered features extracted from the vehicle and battery data of FIG. 7A according to some aspects of the present disclosure. Here, one available feature (raw data) includes charging location 702, which is depicted as a binary data set indicating if a driver charged from home (1=yes) or not (0=no). Another available feature includes SOC % 704 which determines a percentage of available battery capacity. This feature may be used to calculate a SOC % and may be used to feature engineer ΔSOC, a change in SOC % 708, and may be calculated by the difference in subsequent measurements of SOC. This value is configured to captures rates of change 708 as a feature and helps to characterize both charge and discharge rates, with higher values indicating higher current loads, which in turn indicate an accelerated degradation of a battery.

A further engineered feature may include depth of discharge (DoD %) 710 percentage, calculated from the total change in SOC (704) during a discharge cycle. In some examples, greater magnitudes of DoD indicate faster active mass loss and ageing in the battery. The charging power level is represented in 712, and the charging energy (kWh) is represented in 714. The data point may be configured to signify changes (e.g., increasing, decreasing, relative no change) in the data. Thus, for example, the data in 700 may be configured to indicate changes in discharge cycles (change in SOC % is positive/negative/zero), mileage is increasing/decreasing/zero, and depth of discharge is zero/nonzero, and charging power level/energy is zero/nonzero. Other configurations are also contemplated in the present disclosure, including levels or rates of change (e.g., low, medium, high), and/or idle states. Charging energy features 714 may be derived to indicate charging power levels (e.g., slow, fast, rapid; charging levels 0-3, etc.) that reflect the relative and/or maximum charging rate used during a charging session. Higher levels can lead to unwanted chemical reactions that cause irreversible capacity loss in the battery. In some examples, the charging energy may be determined as energy input in kWh per cycle, since batteries continue to age with accumulated energy throughput. The cycle number 716 keeps track of the number of charge/discharge cycles. For this calculation, a 2% change in SOC as a threshold for counting cycles in this example, where anything below this threshold was not counted as a cycle and is regarded as having a negligible effect on battery lifetime.

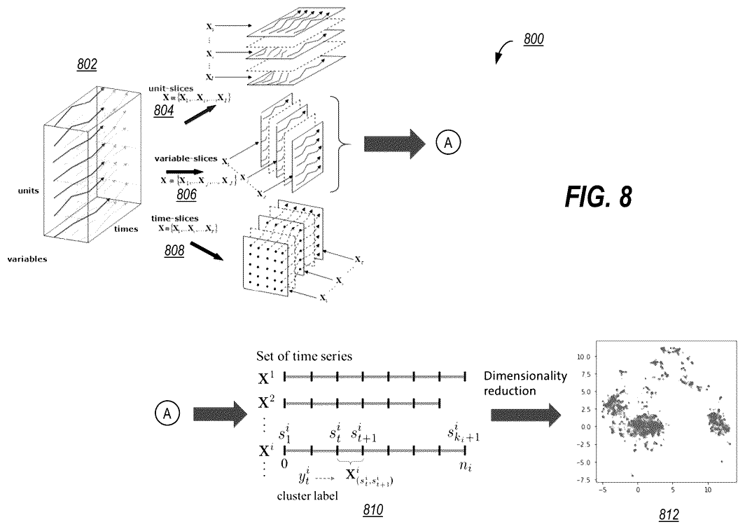

The engineered features of 516 of extracted time series windows 514 may be forwarded for load type clustering in 524, and/or optionally subjected to dimensionality reduction in 518. Turning to FIG. 8, the drawing shows an illustrative process 800 for segmenting multivariate time series data (514), followed by dimensionality reduction (518) of each time series sub-sequence according to some aspects of the present disclosure. In block 802, a time data array may be formed as a geometric representation comprising “units x variables x time”, where the algebraic expression may be represented as

$$X ≡ \{ {x}_{ijt} : i = 1 , … I ; j = 1 , … , J ; t = 1 , … , T \}$$

where i indicates the generic unit (object), j the variable, and t the generic time; xᵢⱼₜ represents the j-th variable observed in the i-th unit at time t. The time data array X can be represented with a bi-dimensional stacked matrix by combining two of the three indices i, j, t on the rows and assigning the remaining index to the columns. The matrices which constitute the generic elements of each stacked matrix, may respectively be expressed as:

$${X}_{i} ≡ \{ {x}_{ijt} : j = 1 , … , J ; t = 1 , … , T \} ( {}^{″} unit {slices}^{″} 804 )$$

$${X}_{j} ≡ \{ {x}_{ijt} : i = 1 , … , I ; t = 1 , … , T \} ( {}^{″} variable {slices}^{″} 806 )$$

$${X}_{t} ≡ \{ {x}_{ijt} : i = 1 , … , I ; j = 1 , … , J \} ( {}^{″} time {slices}^{″} 808 )$$

For example, a time data array can be defined as the set of the bi-dimensional matrices Xᵢ, i.e., X≡{Xᵢ: i=1, . . . I}, {Xₜ: t=1, . . . T}, {Xⱼ: j=1, . . . J}. The time data array can be geometrically represented indicating the elements of one of the plurality (e.g., three) of classification modes as vectors of a vectorial space defined with regard to the other ones.

As the process continues to 810, time series are segmented into subsequences 810, where these subsequences should be equal in length as shown, but can be changed to any length when training different clustering models (e.g., 12 hours, 1 day, 2 days, 1 week, 1 month, etc.). In this example, weekly subsequences were selected, which then become a new pool of samples in the dataset. The purpose of extracting equal length subsequences is to enable the use of similarity metrics (e.g., Manhattan, Euclidean, Minkowski, Cosine) to improve the identification of patterns. Generally, each vehicle time series may be represented as building blocks of these subsequences. Then, the time series subsequences can be projected into lower dimensional space through dimensionality reduction 812.

Turning back to FIG. 5A, dimensionality reduction may be performed in block 518, which is performed with time series length compression 520, comprising a configured number of layers and kernels, and/or Uniform Manifold Approximation and Projection (UMAP) embedding 522 The UMAP processing may be executed on a two-dimensional (2D) or three-dimensional (3D) scale. In some examples, the time series length compression 520 may be configured as an autoencoder. An autoencoder may be configured as a type of neural network in which the input and the output data are the same. As such, it would be part of the so-called unsupervised learning or self-supervised learning because, unlike supervised learning, it requires no human intervention such as data labeling. The architecture of an autoencoder may vary, but generally includes an encoder, that transforms the input into a lower dimensional representation, and a decoder, which reconstructs the original input from the lower dimensional representation. When training these algorithms, the objective is to be able to reconstruct the original input with the minimum amount of information loss. Once the model is trained, data may be compressed at-will by only using the encoder component of the autoencoder.

The AI pipeline 500 may be processed with or without this dimensionality reduction step. In some examples, applying UMAP embedding 522 improves the time efficiency of clustering and internal validation metrics including Silhouette score and Davies-Bouldin index. Regarding block 522, UMAP may be configured to operate similarly to t-distributed stochastic neighbor embedding (t-SNE) to use graph layout algorithms to arrange data in low-dimensional space. Generally, UMAP embedding of 522 may be configured to construct high dimensional graphical representations of the data, and then optimize a low-dimensional graph to be as structurally similar as possible. In order to construct the initial high-dimensional graph, UMAP may construct a “fuzzy simplicial complex”, which may be configured as a representation of a weighted graph, with edge weights representing the likelihood that two points are connected. To determine connectedness, UMAP may extend a radius outward from each point, connecting points when those radii overlap. The UMAP may be configured to choose a radius locally, based on the distance to each point's nth nearest neighbor. UMAP may then make the graph “fuzzy” by decreasing the likelihood of connection as the radius grows. Also, by stipulating that each point must be connected to at least its closest neighbor, UMAP ensures that local structure is preserved in balance with global structure.

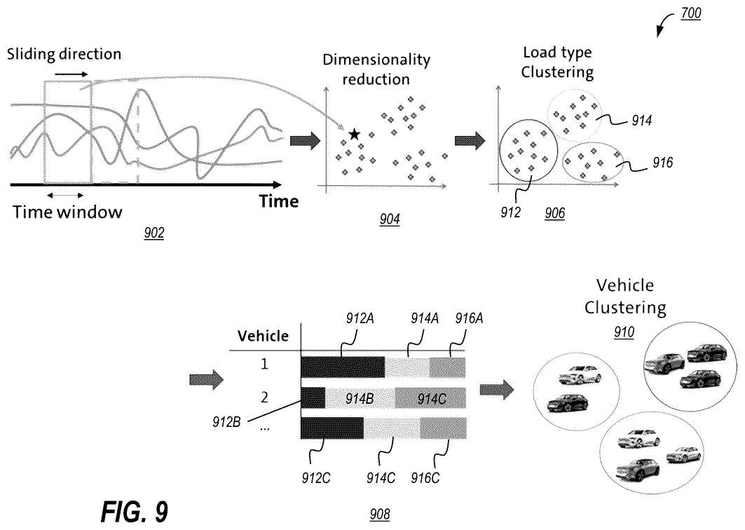

As can be seen in FIG. 5A, the engineered features 516, time series length compression 520 and 3D UMAP embedding 522 may be provided as inputs to clustering in 524, which may be configured to perform load-type clustering in some examples. Referring now to FIG. 9, the drawing shows an illustration of a process for clustering multivariate time series data according to some aspects of the present disclosure. After the pre-processing and feature engineering steps, non-overlapping sliding windows are extracted 902 from the entire time series dataset and time series segments are obtained. The time series segments can optionally be projected into lower dimensional space using dimensionality reduction techniques 904 to obtain time window embeddings. The first round of clustering is performed on the time window segments/embeddings 906 to obtain the different load types (912, 914, 916). Each vehicle (e.g., 502) is characterized 908 by the probability of exhibiting each load type (912A-916A, 912B-916B, 912C-916C), and is subsequently followed by a second round of clustering 910 (see FIG. 5B). In some examples, the final output includes groups of EVs that exhibit the most similar patterns in charging and driving behavior.

Turning now to FIG. 5B, the AI pipeline 500 from FIG. 5A is continued, where the output of the first clustering block 524 is input into block 526, comprising one or more clustering algorithms 528, 530, 532 and 534 in this example. K-means clustering 528 may be configured to perform vector quantization to partition a plurality of observations into n clusters 536, in which each observation belongs to the cluster with the nearest mean (e.g., cluster centers or cluster centroid), serving as a prototype of the cluster. This results in a partitioning of the data space into Voronoi cells. K-means clustering may be advantageous if the process minimizes within-cluster variances (e.g., squared Euclidean distances).

K-medoid clustering 530 may be utilized to partition and break datasets into clusters 538 and minimize the distance between points labeled to be in a cluster and a point designated as the center (medoids or exemplars) of that cluster. K-medoids can be used with arbitrary dissimilarity measures (metrics), and because k-medoids minimize a sum of pairwise dissimilarities (instead of, e.g., a sum of squared Euclidean distances), it is more robust to noise and outliers.

Another clustering algorithm 526 includes agglomerative clustering 532 (also known as agglomerative nesting), which is a hierarchical clustering used to group datasets in clusters based on their similarity. Agglomerative clustering 532 starts by treating each object as a singleton cluster, and pairs of clusters are successively merged until all clusters have been merged into a single, larger, cluster containing all datasets or objects. The result is a tree-based representation of the objects (dendrogram). In some examples, agglomerative clustering may be configured in a “bottom-up” manner. That is, each dataset or object is initially considered as a single-element cluster (leaf). At each step of the algorithm, the two clusters that are the most similar are combined into a new bigger cluster (nodes). This procedure is iterated until all points are member of just one single big cluster (root). Distance between cluster may depends on a data type, domain knowledge etc., and to calculate distance cluster linkage 540 may be determined, based on single linkage (minimum distance between two points of different clusters), complete (maximum distance between each data point), average (average of distances between all pairs of data points) and/or centroid linkage (distance between centroid of clusters).

A further clustering algorithm 526 includes HDBSCAN clustering 534, which may be configured to perform ‘soft clustering’ or ‘fuzzy clustering’, where data points are not necessarily assigned cluster labels, but are instead assigned a vector of probabilities. The length of the vector may be configured to be equal to the number of clusters found. The probability value at the i^{th} entry of the vector is the probability that that point is a member of the i^{th} cluster. This allows points to potentially be a mix of clusters. By looking at the vector data, a user may determine how strongly a point is in a cluster, and which other clusters it is related to. Additionally, noise points will usually be assigned low probabilities of being in any cluster, but nevertheless may be determined which clusters they are closer to, or even if they were very nearly part of a cluster. The HDBSCAN clustering may be configured to include a minimum cluster size 542 (i.e., the smallest size grouping to be considered a cluster), and may be adjusted to reduce or increase the number of clusters, and merging some clusters together. This may be performed as part reoptimizing, in which flat clustering may be desired for greater stability under different interpretations of what constitutes a cluster. Additionally, a minimum sample metric may be used in 542 to determine how conservative the clustering should be performed. The larger the value of minimal samples, the more conservative the clustering will be, and more points will be declared as noise, with clusters being restricted to progressively more dense areas.

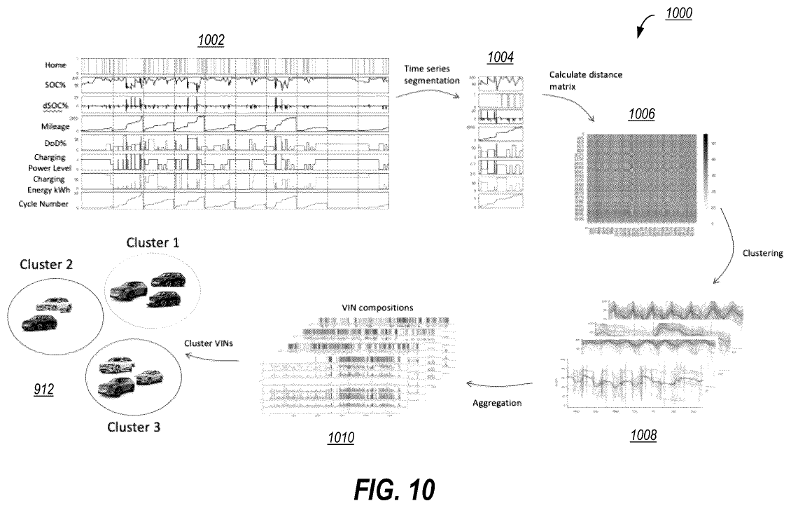

Label types may be loaded in block 544, and load type proportions may be calculated for each VIN in block 546. The output of block 546 may then be subjected to a second clustering in block 548 to perform VIN clustering, wherein the VIN labels in block 550 may then be used for SOH forecasting 552. A further example of the two-clustering approach to group vehicles based on usage is shown in FIG. 10, illustrating a two-step clustering process in which different load types are determined, followed by a probability for a given vehicle exhibiting each load type according to some aspects of the present disclosure. Extracted features 1002 may be subjected to time series segmentation for form time window segments/UMAP embeddings 104, and distance matrixes are calculated in 1006. The first round of clustering is performed on the time window segments/UMAP embeddings to obtain the different load types 1008.

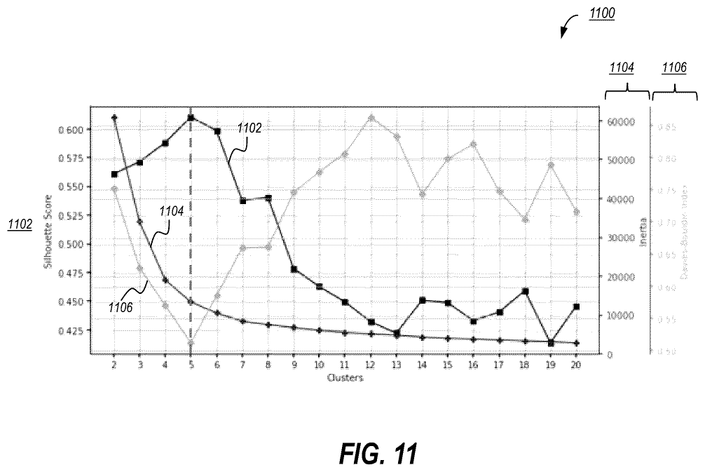

In this example, the number of different load type clusters are not known (no ground truth), thus an optimal number may be identified by using elbow method, Silhouette score, and Davies-Bouldin index. This may be done by varying the number of clusters and recording the scores each time, as shown in FIG. 11, which illustrates a simulated chart 1100 demonstrating a process for determining the optimal number of clusters through Silhouette score, inertia, and Davies-Bouldin index according to some aspects of the present disclosure. In some examples, the Silhouette score 1102 should be maximized, the inflection point(s) of inertia 1104 should be found (shown in the figure as dotted line), and Davies-Bouldin index 1106 should be minimized. Each vehicle may then be characterized by the probability of exhibiting each load type 1010, which may then be used as features for performing a second round of clustering 913. The final output may include groups of EVs that have the most similar battery usage characteristics. In some examples, each vehicle may be clustered based on their load type composition. Thus, the algorithm may identify a plurality of clusters of vehicles that exhibit the most similar load types throughout their life. For example, a first load type (e.g., “load type 0”) may be determined to be most common in a respective cluster (“cluster 0”), a second load type (e.g., “load type 2”) may be determined to be most common in a respective cluster (“cluster 1”), a third load type (e.g., “load type 5”) may be determined to be most common in a respective cluster (“cluster 3”), and so on. Based on the second clustering, individual vehicles (e.g., VIN 51) may be determined to belong to one cluster (e.g., “cluster 0”), while other individual vehicles (e.g., VIN 78) may be determined to belong to another cluster (e.g., “cluster 1”).

To summarize the configuration of FIGS. 5A-5B, once the time series signals are extracted from the vehicles and compiled within a dataset, resampling with linear interpolation is performed for achieving sampling regularity. This is immediately followed by down sampling to lower sampling frequency to save memory and limit complexity of the clustering algorithms. Since degradation of battery health occurs over a long period of time, it should sufficient to use a lower sampling frequency. The multivariate time series data may be segmented into any size of non-overlapping equal length time windows, followed by feature engineering. The application of dimensionality reduction in the AI pipeline may be optional. The first clustering step (e.g., 524) may be configured for identifying load types. The load types are then aggregated into their respective vehicle identification numbers (VIN) and a vehicle load type composition is obtained. The second clustering step (e.g., 548) may be performed on vehicle load type composition to output the vehicle clusters that have the most similar usage patterns, and can then be applied to support SOH forecasting (552). In some examples, the feature engineering and window segmentation steps may be reversed, where feature engineering is performed first, and then subjected to segmentation (e.g., reversing 514 and 516 in FIG. 5A).

The technologies and techniques disclosed in FIGS. 5A-5B may be executed entirely within a server/cloud system (e.g., 216) communicatively coupled (e.g., via network 214) to one or more vehicles (e.g., 101), or may executed using a combination of processing functions shared between the server/cloud system and each vehicle. In one example, each vehicle 101 may simply transmit raw multivariate time series data (504) to the server/cloud, at which point the server/cloud performs the remaining processing steps to train (e.g., 506-552) the vehicle cluster data and process new vehicle data an AI forecasting model to determine a SOH forecast for the new vehicle/battery. In another example, some of the pre-processing steps (e.g., 502-524) are performed in the vehicle, and the remaining steps (526-552) are performed in the server/cloud. One skilled in the art will appreciate that numerous other configurations are contemplated in the present disclosure, and that the specific processing steps are not intended to be limiting.

It should be understood that SOH forecasting (552) has a multitude of technical application beyond data processing and analysis. For example, once a SOH forecast 552 is determined for a cluster, the server/cloud may transmit a control signal comprising control data (e.g., via network 214) to each of the vehicles belonging to the cluster, wherein the control signal includes executable information for the vehicle. The executable information may include diagnostic information, which, when executed by a processor (e.g., 107) of the vehicle, allows the vehicle to perform diagnostic functions in relation to the battery (e.g., via the BMS 105). The diagnostic function may be associated with monitoring one or more vehicle components as they relate to battery function, and/or monitor and/or alter the frequency of reporting the time series data (504) to the server/cloud. In some examples, the executable information may include vehicle battery management instructions, which, when executed by the vehicle's processor (e.g., 107) controls some aspect of battery management (e.g., via BM 105) by controlling operation of one or more vehicle circuits to perform functions that conserve and/or prolong battery life.

In some examples, each vehicle in a cluster may not always forecast the same SOH value. As the value may be assumed to be close, the clustering as disclosed herein may determine usage similarities that do not need to have exactly the same SOH value via forecasting algorithms. For example, once an AI forecasting model is trained on each cluster, using these multitude of models, a SOH may be forecast more accurately than when training on all data. Once a more accurate SOH forecast 552 is determined for each vehicle, the server/cloud may transmit a control signal comprising control data (e.g., via network 214) to each of the vehicles which show degradation by SOH forecasting, wherein the control signal includes executable information for the vehicle.

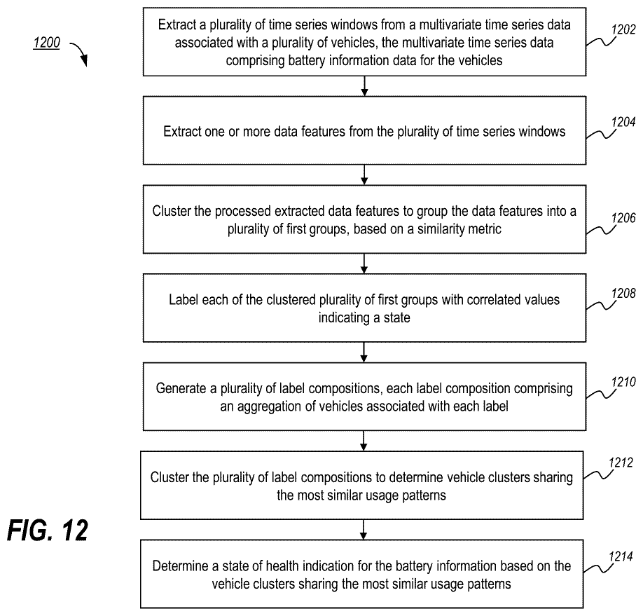

FIG. 12 shows a flowchart illustrating a process 1200 for processing a state of health for a battery under some aspects of the present disclosure. In block 1202, one or more processors (e.g., server/cloud 216, and/or processor 107) extract a plurality of time series windows from a multivariate time series data associated with a plurality of vehicles (e.g., 502), the multivariate time series data comprising battery information data for the vehicles. In some examples, the multivariate time series data may include the raw data received from vehicles 502 and stored in block 504. In block 1204, the one or more processors may extract one or more data features from the plurality of time series windows. In some examples, one or more data features may be extracted utilizing feature engineering disclosed in 514 of FIG. 5A. In block 1206, one or more processors may cluster the processed extracted data features to group the data features into a plurality of first groups, based on a similarity metric. In some examples, the processed extracted data may be clustered and grouped using load type clustering 524 and 526, discussed above in connection with FIGS. 5A-5B.

In block 1208, one or more processor may label each of the clustered plurality of first groups with correlated values indicating a state. In some examples, the labeling of data may be performed during or after clustering (524, 526) in block 544. In block 1210, the one or more processors may generate a plurality of label compositions, each label composition comprising an aggregation of vehicles associated with each label. In some examples, the label compositions may be generated via blocks 546-548 of FIG. 5B. In block 1212, the one or more processors may cluster the plurality of label compositions to determine vehicle clusters sharing the most similar usage patterns. In some examples, the clustering of label compositions may be performed in blocks 548-550 of FIG. 5B. In block 1214, the one or more processors may determine a state of health (SOH) indication for the battery information based on the vehicle clusters sharing the most similar usage patterns. In some examples, the SOH indication and forecasting may be performed in block 552 of FIG. 5B by a different forecasting model.

As described above, some or all illustrated features may be omitted in a particular implementation within the scope of the present disclosure, and some illustrated features may not be required for implementation of all examples. In some examples, the methods and processes described herein may be performed by a vehicle (e.g., 101), as described above and/or by a processor/processing system or circuitry (e.g., 102-111) or by any suitable means for carrying out the described functions.

The following provides an overview of aspects of the present disclosure:

Aspect 1 is a battery management system for processing a state of health for a battery, comprising: at least one data storage configured to store computer program instructions; and at least one processor, operatively coupled to the at least one data storage, wherein the at least one processor is configured to: extract a plurality of time series windows from a multivariate time series data associated with a plurality of vehicles, the multivariate time series data comprising battery information data for the vehicles; extract one or more data features from the plurality of time series windows; cluster the processed extracted data features to group the data features into a plurality of first groups, based on a similarity metric; label each of the clustered plurality of first groups with correlated values indicating a state; generate a plurality of label compositions, each label composition comprising an aggregation of vehicles associated with each label; cluster the plurality of label compositions to determine vehicle clusters sharing the most similar usage patterns; and determine a state of health indication for the battery information based on the vehicle clusters sharing the most similar usage patterns.

Aspect 2 may be combined with aspect 1 and includes that the extracted one or more data features comprise one or more of (i) vehicle charging location, (ii) state of battery charge, (iii) change in state of charge, (iv) depth of discharge, (v) change in vehicle milage, (vi) battery charging power, (vii) charging energy, (viii) a cycle count, and/or (ix) temperature.

Aspect 3 may be combined with any of aspects 1 and/or 2, and includes that the at least one processor is configured to perform dimensionality reduction prior to clustering the processed extracted data features to group the data features into the plurality of first groups.

Aspect 4 may be combined with any of aspects 1 through 3, and includes that the dimensionality reduction comprises time series length compression and/or Uniform Manifold Approximation and Projection (UMAP) embedding. Aspect 5 may be combined with any of aspects 1 through 4, and includes that the at least one processor is configured to cluster the plurality of first groups to generate the second group using one of k-means, k-medoids, agglomerative or HDBSCAN clustering.

Aspect 6 may be combined with any of aspects 1 through 5, and includes that the at least one processor is configured to label each of the clustered plurality of first groups according to a load type.

Aspect 7 may be combined with any of aspects 1 through 6, and includes that the at least one processor is configured to generate a control signal based on the determined a state of health indication for controlling operation of a vehicle.

Aspect 8 is a computer-implemented method of processing a state of health for a battery in a battery management system, comprising: extracting a plurality of time series windows from a multivariate time series data associated with a plurality of vehicles, the multivariate time series data comprising battery information data for the vehicles; extracting one or more data features from the plurality of time series windows; clustering the processed extracted data features to group the data features into a plurality of first groups, based on a similarity metric; labeling each of the clustered plurality of first groups with correlated values indicating a state; generating a plurality of label compositions, each label composition comprising an aggregation of vehicles associated with each label; clustering the plurality of label compositions to determine vehicle clusters sharing the most similar usage patterns; and determining a state of health indication for the battery information based on the vehicle clusters sharing the most similar usage patterns.

Aspect 9 may be combined with aspect 8 and includes that the extracted one or more data features comprise one or more of (i) vehicle charging location, (ii) state of battery charge, (iii) change in state of charge, (iv) depth of discharge, (v) change in vehicle milage, (vi) battery charging power, (vii) charging energy, (viii) a cycle count, and/or (ix) temperature.

Aspect 10 may be combined with any of aspects 8 and/or 9, and includes performing dimensionality reduction prior to clustering the processed extracted data features to group the data features into the plurality of first groups.

Aspect 11 may be combined with any of aspects 8 through 10, and includes that the dimensionality reduction comprises time series length compression and/or Uniform Manifold Approximation and Projection (UMAP) embedding.

Aspect 12 may be combined with any of aspects 8 through 11, and includes clustering the plurality of first groups to generate the second group using one of k-means, k-medoids, agglomerative or HDBSCAN clustering.

Aspect 13 may be combined with any of aspects 8 through 12, and includes labeling each of the clustered plurality of first groups according to a load type.

Aspect 14 may be combined with any of aspects 8 through 13, and includes generating a control signal based on the determined a state of health indication for controlling operation of a vehicle.

Aspect 15 is a non-transitory computer-readable medium storing executable instructions for processing a state of health for a battery for a battery management system, when executed by one or more processors, causes one or more processors to: extract a plurality of time series windows from a multivariate time series data associated with a plurality of vehicles, the multivariate time series data comprising battery information data for the vehicles; extract one or more data features from the plurality of time series windows; cluster the processed extracted data features to group the data features into a plurality of first groups, based on a similarity metric; label each of the clustered plurality of first groups with correlated values indicating a state; generate a plurality of label compositions, each label composition comprising an aggregation of vehicles associated with each label; cluster the plurality of label compositions to determine vehicle clusters sharing the most similar usage patterns; and determine a state of health indication for the battery information based on the vehicle clusters sharing the most similar usage patterns.

Aspect 16 may be combined with aspect 15 and further includes that the extracted one or more data features comprise one or more of (i) vehicle charging location, (ii) state of battery charge, (iii) change in state of charge, (iv) depth of discharge, (v) change in vehicle milage, (vi) battery charging power, (vii) charging energy, (viii) a cycle count, and/or (ix) temperature.

Aspect 17 may be combined with any of aspects 15 and/or 16, and includes that the executable instructions for processing a state of health for a battery, when executed by one or more processors, causes one or more processors to: perform dimensionality reduction prior to clustering the processed extracted data features to group the data features into the plurality of first groups

Aspect 18 may be combined with any of aspects 15 through 17, and includes that the dimensionality reduction comprises time series length compression and/or Uniform Manifold Approximation and Projection (UMAP) embedding.

Aspect 19 may be combined with any of aspects 15 through 18, and includes that the executable instructions for processing a state of health for a battery, when executed by one or more processors, causes one or more processors to cluster the plurality of first groups to generate the second group using one of k-means, k-medoids, agglomerative or HDBSCAN clustering.

Aspect 20 may be combined with any of aspects 15 through 19, and includes that the executable instructions for processing a state of health for a battery, when executed by one or more processors, causes one or more processors to label each of the clustered plurality of first groups according to a load type.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A battery management system for processing a state of health for a battery, comprising:
at least one data storage configured to store computer program instructions; and
at least one processor, operatively coupled to the at least one data storage, wherein the at least one processor is configured to:
extract a plurality of time series windows from a multivariate time series data associated with a plurality of vehicles, the multivariate time series data comprising battery information data for the vehicles;
extract one or more data features from the plurality of time series windows;
cluster the processed extracted data features to group the data features into a plurality of first groups, based on a similarity metric;
label each of the clustered plurality of first groups with correlated values indicating a state;
generate a plurality of label compositions, each label composition comprising an aggregation of vehicles associated with each label;
cluster the plurality of label compositions to determine vehicle clusters sharing the most similar usage patterns; and
determine a state of health indication for the battery information based on the vehicle clusters sharing the most similar usage patterns.

2. The computing system of claim 1, wherein the extracted one or more data features comprise one or more of (i) vehicle charging location, (ii) state of battery charge, (iii) change in state of charge, (iv) depth of discharge, (v) change in vehicle milage, (vi) battery charging power, (vii) charging energy, (viii) a cycle count, and/or (ix) temperature.

3. The computing system of claim 1, wherein the at least one processor is configured to perform dimensionality reduction prior to clustering the processed extracted data features to group the data features into the plurality of first groups.

4. The computing system of claim 3, wherein the dimensionality reduction comprises time series length compression and/or Uniform Manifold Approximation and Projection (UMAP) embedding.

5. The computing system of claim 1, wherein the at least one processor is configured to cluster the plurality of first groups to generate the second group using one of k-means, k-medoids, agglomerative or HDBSCAN clustering.

6. The computing system of claim 1, wherein the at least one processor is configured to label each of the clustered plurality of first groups according to a load type.

7. The computing system of claim 1, wherein the at least one processor is configured to generate a control signal based on the determined a state of health indication for controlling operation of a vehicle.

8. A computer-implemented method of processing a state of health for a battery in a battery management system, comprising:
extracting a plurality of time series windows from a multivariate time series data associated with a plurality of vehicles, the multivariate time series data comprising battery information data for the vehicles;
extracting one or more data features from the plurality of time series windows;
clustering the processed extracted data features to group the data features into a plurality of first groups, based on a similarity metric;
labeling each of the clustered plurality of first groups with correlated values indicating a state;
generating a plurality of label compositions, each label composition comprising an aggregation of vehicles associated with each label;
clustering the plurality of label compositions to determine vehicle clusters sharing the most similar usage patterns; and
determining a state of health indication for the battery information based on the vehicle clusters sharing the most similar usage patterns.

9. The computer-implemented method of claim 8, wherein the extracted one or more data features comprise one or more of (i) vehicle charging location, (ii) state of battery charge, (iii) change in state of charge, (iv) depth of discharge, (v) change in vehicle milage, (vi) battery charging power, (vii) charging energy, (viii) a cycle count, and/or (ix) temperature.

10. The computer-implemented method of claim 8, further comprising performing dimensionality reduction prior to clustering the processed extracted data features to group the data features into the plurality of first groups.

11. The computer-implemented method of claim 10, wherein the dimensionality reduction comprises time series length compression and/or Uniform Manifold Approximation and Projection (UMAP) embedding.

12. The computer-implemented method of claim 8, further comprising clustering the plurality of first groups to generate the second group using one of k-means, k-medoids, agglomerative or HDBSCAN clustering.

13. The computer-implemented method of claim 8, further comprising labeling each of the clustered plurality of first groups according to a load type.

14. The computer-implemented method of claim 8, further comprising generating a control signal based on the determined a state of health indication for controlling operation of a vehicle.

15. A non-transitory computer-readable medium storing executable instructions for processing a state of health for a battery for a battery management system, when executed by one or more processors, causes one or more processors to:
extract a plurality of time series windows from a multivariate time series data associated with a plurality of vehicles, the multivariate time series data comprising battery information data for the vehicles;
extract one or more data features from the plurality of time series windows;
cluster the processed extracted data features to group the data features into a plurality of first groups, based on a similarity metric;
label each of the clustered plurality of first groups with correlated values indicating a state;
generate a plurality of label compositions, each label composition comprising an aggregation of vehicles associated with each label;
cluster the plurality of label compositions to determine vehicle clusters sharing the most similar usage patterns; and
determine a state of health indication for the battery information based on the vehicle clusters sharing the most similar usage patterns.

16. The non-transitory computer-readable medium of claim 15, wherein the extracted one or more data features comprise one or more of (i) vehicle charging location, (ii) state of battery charge, (iii) change in state of charge, (iv) depth of discharge, (v) change in vehicle milage, (vi) battery charging power, (vii) charging energy, (viii) a cycle count, and/or (ix) temperature.

17. The non-transitory computer-readable medium of claim 15, wherein the executable instructions for processing a state of health for a battery, when executed by one or more processors, causes one or more processors to:
perform dimensionality reduction prior to clustering the processed extracted data features to group the data features into the plurality of first groups.

18. The computing system of claim 17, wherein the dimensionality reduction comprises time series length compression and/or Uniform Manifold Approximation and Projection (UMAP) embedding.

19. The non-transitory computer-readable medium of claim 15, wherein the executable instructions for processing a state of health for a battery, when executed by one or more processors, causes one or more processors to cluster the plurality of first groups to generate the second group using one of k-means, k-medoids, agglomerative or HDBSCAN clustering.

20. The non-transitory computer-readable medium of claim 15, wherein the executable instructions for processing a state of health for a battery, when executed by one or more processors, causes one or more processors to label each of the clustered plurality of first groups according to a load type.
